(19) United States
(12) Patent Application Publication
(10) Pub. No.: US 2022/0114510 A1
(43) Pub. Date: Apr. 14, 2022

(54) WORK SITE MANAGEMENT SYSTEM AND WORK SITE MANAGEMENT METHOD

(71) Applicant: Komatsu Ltd., Tokyo (JP)

(72) Inventors: Takashi Hiranaka, Tokyo (JP); Kenta Osagawa, Tokyo (JP)

(73) Assignee: Komatsu Ltd., Tokyo (JP)

(21) Appl. No.: 17/428,318

(22) PCT Filed: Mar. 16, 2020
(86) PCT No.: PCT/JP2020/011574

§ 371 Date: Aug. 4, 2021

(30) Foreign Application Priority Data
Mar. 19, 2019 (JP) 2019-051977

(51) Int. Cl. G06Q 10/06; G08G 1/00

(52) U.S. Cl. CPC G06Q 10/0631; G08G 1/207

(57) ABSTRACT

A work site management system includes: an entry-prohibited area setting unit that sets an entry-prohibited area to prohibit an entry of a manned transport vehicle at a discharging site in a work site; and a notification unit that notifies the manned transport vehicle of the entry-prohibited area.

### FIELD

The present disclosure relates to a work site management system and a work site management method.

### BACKGROUND

In a work site in a wide area such as a mine, an unmanned vehicle operates in some cases.

### CITATION LIST

### Patent Literature

Patent Literature 1: JP 2016-153987 A

### SUMMARY

### Technical Problem

There is a case where an unmanned transport vehicle and a manned transport vehicle coexist and operate at a work site. If the manned transport vehicle enters the work area where the unmanned transport vehicle operates, the safety of the work site is likely to deteriorate.

### Solution to Problem

According to an aspect of the present invention, a work site management system comprises: an entry-prohibited area setting unit that sets an entry-prohibited area to prohibit an entry of a manned transport vehicle at a discharging site in a work site; and a notification unit that notifies the manned transport vehicle of the entry-prohibited area.

### Advantageous Effects of Invention

According to an aspect of the present invention, it is possible to suppress deterioration in safety at a work site.

### BRIEF DESCRIPTION OF DRAWINGS

FIG. 1 is a view schematically illustrating examples of a management system, an unmanned vehicle, and a manned vehicle according to an embodiment.

FIG. 2 is a view schematically illustrating an example of a work site according to the embodiment.

FIG. 3 is a functional block diagram illustrating an example of the management system according to the embodiment.

FIG. 4 is a view schematically illustrating an example of a discharging site according to the embodiment.

FIG. 5 is a view schematically illustrating an example of a notification device according to the embodiment.

FIG. 6 is a flowchart illustrating an example of a management method according to the embodiment.

FIG. 7 is a block diagram illustrating an example of a computer system.

### DESCRIPTION OF EMBODIMENTS

Hereinafter, an embodiment of the present disclosure will be described with reference to the drawings, but the present invention is not limited thereto. Components of the embodiment to be described below can be combined as appropriate. In addition, there is also a case where some components are not used.

<Management System>

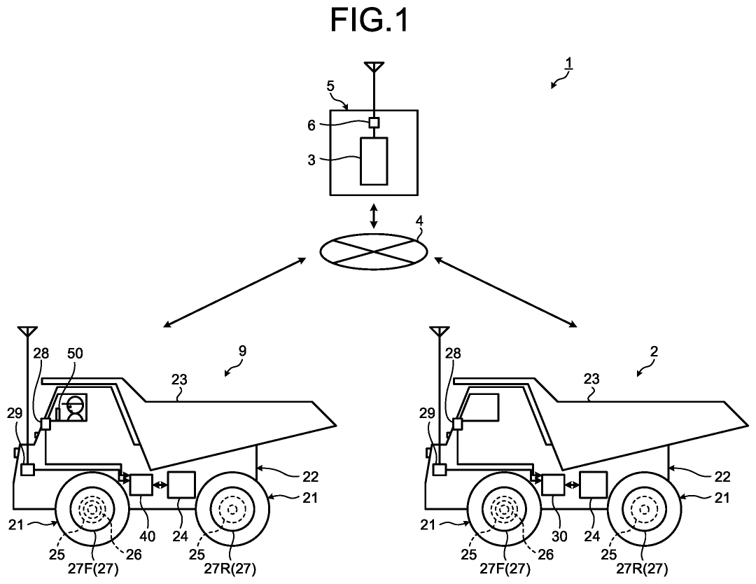

FIG. 1 is a view schematically illustrating examples of a management system 1, an unmanned vehicle 2, which is an unmanned transport vehicle, and a manned vehicle 9 which is a manned transport vehicle according to the embodiment. Each of the unmanned vehicle 2 and the manned vehicle 9 operates at a work site. In the embodiment, the work site is a mine or a quarry. The mine refers to a place or a business site where a mineral is mined.

The unmanned vehicle 2 refers to a vehicle that operates in an unmanned manner without any driving operation performed by a driver. The manned vehicle 9 refers to a vehicle that operates with the driver's driving operation.

The unmanned vehicle 2 and the manned vehicle 9 are dump trucks which are a kind of transport vehicle that travels at the work site and transports a cargo. As the cargo transported by the unmanned vehicle 2 and the manned vehicle 9, ore or dirt excavated in the mine or the quarry is exemplified.

Note that the work site is not limited to the mine or the quarry. The work site may be any work site where the transport vehicle carries the cargo.

The management system 1 includes a management device 3 and a communication system 4. The management device 3 includes a computer system and is installed in a control facility 5 at the work site, for example. The communication system 4 performs communication among the management device 3, the unmanned vehicle 2, and the manned vehicle 9. The management device 3 is connected with a wireless communication device 6. The communication system 4 includes the wireless communication device 6. The management device 3, the unmanned vehicle 2, and the manned vehicle 9 wirelessly communicate with each other via the communication system 4.

<Unmanned Vehicle>

The unmanned vehicle 2 travels at the work site based on travel course data transmitted from the management device 3. The unmanned vehicle 2 includes a traveling device 21, a vehicle main body 22 supported by the traveling device 21, a dump body 23 supported by the vehicle main body 22, a control device 30, a position detection device 28, and a wireless communication device 29.

The traveling device 21 includes a drive device 24 that drives the traveling device 21, a brake device 25 that brakes the traveling device 21, a steering device 26 that adjusts a traveling direction, and wheels 27.

The unmanned vehicle 2 travels autonomously as the wheels 27 rotate. The wheels 27 include front wheels 27F and rear wheels 27R. Tires are mounted on the wheels 27.

The drive device 24 generates a driving force for accelerating the unmanned vehicle 2. The drive device 24 includes an internal combustion engine such as a diesel engine. Note that the drive device 24 may include an electric motor. Power generated by the drive device 24 is transmitted to the rear wheels 27R. The brake device 25 generates a braking force for decelerating or stopping the unmanned vehicle 2. The steering device 26 can adjust the traveling direction of the unmanned vehicle 2. The traveling direction of the unmanned vehicle 2 includes a direction of a front portion of the vehicle main body 22. The steering device 26 adjusts the traveling direction of the unmanned vehicle 2 by steering the front wheels 27F.

The control device 30 can communicate with the management device 3 present outside the unmanned vehicle 2 by, for example, the wireless communication device 29. The control device 30 outputs an accelerator command for operating the drive device 24, a brake command for operating the brake device 25, and a steering command for operating the steering device 26. The drive device 24 generates a driving force for accelerating the unmanned vehicle 2 based on the accelerator command output from the control device 30. As the output of the drive device 24 is adjusted, the travel speed of the unmanned vehicle 2 is adjusted. The brake device 25 generates a braking force for decelerating the unmanned vehicle 2 based on the brake command output from the control device 30. The steering device 26 generates a force for changing a direction of the front wheels 27F so as to make the unmanned vehicle 2 travel straight or swing based on the steering command output from the control device 30.

The position detection device 28 detects a position of the unmanned vehicle 2. The position of the unmanned vehicle 2 is detected using a global navigation satellite system (GNSS). The global navigation satellite system includes a global positioning system (GPS). The global navigation satellite system detects an absolute position of the unmanned vehicle 2 specified by coordinate data of the latitude, longitude, and altitude. The position of the unmanned vehicle 2 specified in a global coordinate system is detected by the global navigation satellite system. The global coordinate system is a coordinate system fixed to the earth. The position detection device 28 includes a GNSS receiver and detects the absolute position (coordinates) of the unmanned vehicle 2.

The wireless communication device 29 performs wireless communication. The communication system 4 includes the wireless communication device 29. The wireless communication device 29 can wirelessly communicate with the management device 3.

<Manned Vehicle>

The manned vehicle 9 travels at the work site based on the driving operation of the driver riding in a driver's cab of the manned vehicle 9. The manned vehicle 9 includes the traveling device 21, the vehicle main body 22, the dump body 23, the drive device 24, the brake device 25, the steering device 26, the wheels 27 including the front wheels 27F and the rear wheels 27R, the position detection device 28, the wireless communication device 29, a control device 40, and a notification device 50.

The position detection device 28 of the manned vehicle 9 detects a position of the manned vehicle 9. The wireless communication device 29 of the manned vehicle 9 can wirelessly communicate with the management device 3.

The control device 40 can communicate with the management device 3 present outside the manned vehicle 9 by, for example, the wireless communication device 29. An accelerator pedal for operating the drive device 24, a brake pedal for operating the brake device 25, and a steering wheel for operating the steering device 26 are disposed in the driver's cab. The accelerator pedal, the brake pedal, and the steering wheel are operated by the driver. The drive device 24 generates a driving force for accelerating the manned vehicle 9 based on the amount of operation of the accelerator pedal. As the output of the drive device 24 is adjusted, the travel speed of the manned vehicle 9 is adjusted. The brake device 25 generates a braking force for decelerating the manned vehicle 9 based on the amount of operation of the brake pedal. The steering device 26 generates a force for changing a direction of the front wheels 27F in order to cause the manned vehicle 9 to move straight or swing based on the amount of operation of the steering wheel.

The notification device 50 is arranged in the driver's cab. The notification device 50 operates based on notification data transmitted from the management device 3. Examples of the notification device 50 include a display device that displays display data and a voice output device that outputs a voice. As the display device, a flat panel display, such as a liquid crystal display (LCD) and an organic electroluminescence display (OELD), is exemplified.

<Work Site>

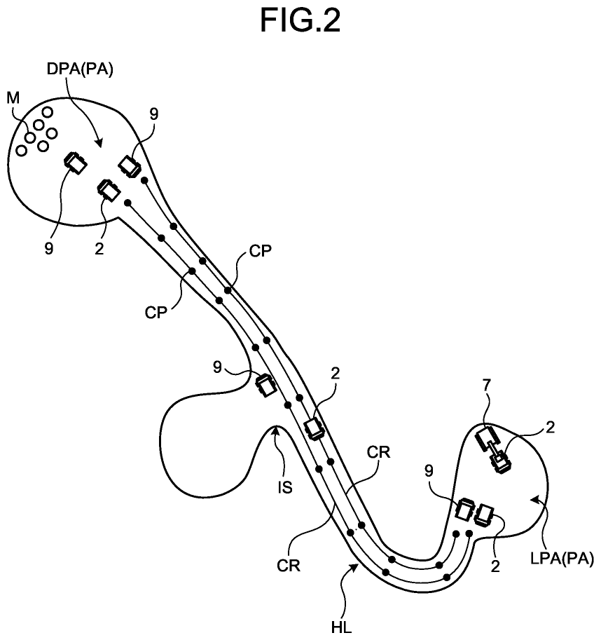

FIG. 2 is a view schematically illustrating an example of the work site according to the embodiment. The unmanned vehicle 2 and the manned vehicle 9 travel on at least a part of a work site PA of a mine and a travel path HL leading to the work site PA. The work site PA includes at least one of a loading site LPA and a discharging site DPA. The travel path HL includes an intersection IS.

The loading site LPA refers to an area where loading work for loading the cargo on the unmanned vehicle 2 and the manned vehicle 9 is performed. A loader 7 operates at the loading site LPA. The loader 7 is, for example, an excavator or a rope excavator having working equipment. The discharging site DPA refers to an area where discharging work for discharging the cargo from the unmanned vehicle 2 and the manned vehicle 9 is performed. For example, a discharging position M is provided in the discharging site DPA.

The unmanned vehicle 2 travels at the work site based on the travel course data indicating a travel condition of the unmanned vehicle 2. As illustrated in FIG. 2, the travel course data includes a plurality of course points CP set at intervals. The course point CP defines a target position of the unmanned vehicle 2. A target travel speed and a target travel direction of the unmanned vehicle 2 are set for each of the plurality of course points CP. In addition, the travel course data includes a travel course CR indicating a target travel route of the unmanned vehicle 2. The travel course CR is defined by a line connecting the plurality of course points CP.

The travel course CR is set in the travel path HL and the work site PA. The unmanned vehicle 2 travels on the travel path HL according to the travel course CR.

The travel course data is generated in the management device 3. The management device 3 transmits the generated travel course data to the control device 30 of the unmanned vehicle 2 via the communication system 4. The control device 30 controls the traveling device 21 such that the unmanned vehicle 2 travels along the travel course CR based on the travel course data and travels according to the target travel speed and the target travel direction set for each of the plurality of course points CP.

In the present embodiment, the unmanned vehicle 2 and the manned vehicle 9 operate in a mixed manner at the work site. Both the unmanned vehicle 2 and the manned vehicle 9 travel in the travel path HL and the work site PA. For example, when shifting from a work site where only the manned vehicle 9 operates as a transport vehicle to a work site where only the unmanned vehicle 2 operates, both the unmanned vehicle 2 and manned vehicle 9 operate at a work site during the shift period.

<Management Device and Control Device>

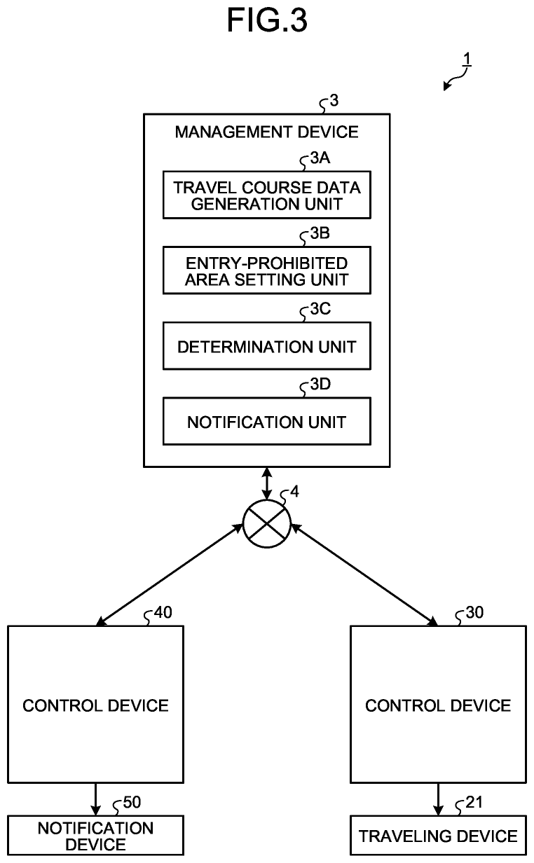

FIG. 3 is a functional block diagram illustrating an example of the management system 1 according to the present embodiment. The management system 1 includes the management device 3, the control device 30, and the control device 40.

The management device 3 includes a travel course data generation unit 3A, an entry-prohibited area setting unit 3B, a determination unit 3C, and a notification unit 3D.

The travel course data generation unit 3A generates travel course data including the travel course CR. The travel course data generated by the travel course data generation unit 3A is transmitted to the control device 30 of the unmanned vehicle 2.

The entry-prohibited area setting unit 3B sets an entry-prohibited area AR that prohibits the entry of the manned vehicle 9 at the work site. In the present embodiment, the entry-prohibited area AR is set at, for example, the discharging site DPA. The entry-prohibited area AR is set by, for example, an administrator who can operate the management device 3. The entry of the unmanned vehicle 2 to the entry-prohibited area AR is permitted. The unmanned vehicle 2 can operate in the entry-prohibited area AR.

Note that the entry-prohibited area AR may be set to a place different from the discharging site DPA in the work site. The administrator can set the entry-prohibited area AR at any place in the work site where the entry of the manned vehicle 9 is desirably prohibited.

The determination unit 3C determines whether the manned vehicle 9 enters the entry-prohibited area AR based on the position of the manned vehicle 9. The determination on whether the manned vehicle 9 enters the entry-prohibited area AR includes determination on whether the manned vehicle 9 has entered the entry-prohibited area AR and determination on whether the manned vehicle 9 is approaching the entry-prohibited area AR. The determination unit 3C can determine whether the manned vehicle 9 has entered the entry-prohibited area AR based on the position of the manned vehicle 9. The determination unit 3C can determine whether the manned vehicle 9 is approaching the entry-prohibited area AR based on the position of the manned vehicle 9. The position of the manned vehicle 9 is detected by the position detection device 28. The determination unit 3C can acquire the position of the manned vehicle 9 by receiving detection data of the position detection device 28.

The notification unit 3D notifies the manned vehicle 9 of the entry-prohibited area AR. When the determination unit 3C determines that the manned vehicle 9 has entered the entry-prohibited area AR, the notification unit 3D notifies that the manned vehicle 9 has entered the entry-prohibited area AR. When the determination unit 3C determines that the manned vehicle 9 is approaching the entry-prohibited area AR, the notification unit 3D notifies that the manned vehicle 9 is approaching the entry-prohibited area AR.

The notification unit 3D notifies the notification device 50, provided in the manned vehicle 9, of the entry-prohibited area AR. The notification unit 3D notifies the notification device 50 that the manned vehicle 9 has entered the entry-prohibited area AR or that the manned vehicle 9 is approaching the entry-prohibited area AR.

The control device 30 acquires the travel course data of the unmanned vehicle 2 transmitted from the travel course data generation unit 3A, and controls the traveling of the unmanned vehicle 2. The control device 30 controls the traveling device 21 of the unmanned vehicle 2 so as to travel according to the travel course data.

The control device 40 controls the notification device 50 based on the notification data transmitted from the notification unit 3D. The notification data includes a position and a size of the entry-prohibited area AR and whether the manned vehicle 9 has entered the entry-prohibited area AR. The notification device 50 operates based on the notification data output from the notification unit 3D.

<Operation at Discharging Site>

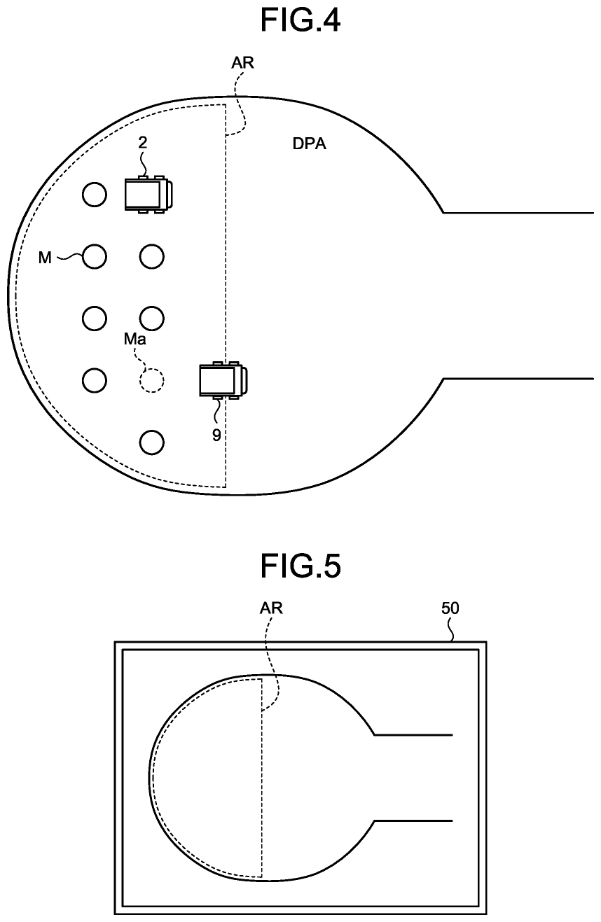

FIG. 4 is a view schematically illustrating an example of the discharging site DPA according to the embodiment. As illustrated in FIG. 4, a plurality of discharging positions M are set in the discharging site DPA. The discharging position M is a position where the discharging work of the unmanned vehicle 2 is carried out. The unmanned vehicle 2 travels to the discharging position M based on the travel course data, and discharges earth to the discharging position M.

If the manned vehicle 9 discharges earth at the discharging position M, the discharging work of the unmanned vehicle 2 is hindered. For example, if the manned vehicle 9 discharges earth at the discharging position Ma where the discharging work of the unmanned vehicle 2 is scheduled, the discharging work of the unmanned vehicle 2 is hindered.

In addition, the unmanned vehicle 2 travels to the discharging position M based on the travel course data. On the other hand, the manned vehicle 9 can discharge earth at an arbitrary position. If the manned vehicle 9 discharges earth on the travel course CR of the unmanned vehicle 2, the traveling of the unmanned vehicle 2 is hindered.

In the present embodiment, the entry-prohibited area setting unit 3B sets the entry-prohibited area AR so as to include the discharging position M where the discharging work of the unmanned vehicle 2 is carried out. The discharging position M included in the entry-prohibited area AR may be one or plural. In addition, the entry-prohibited area setting unit 3B sets the entry-prohibited area AR so as to include the travel course CR of the unmanned vehicle 2.

<Notification Device>

FIG. 5 is a view schematically illustrating an example of the notification device 50 according to the embodiment. The notification device 50 includes the display device. As illustrated in FIG. 5, the entry-prohibited area AR is displayed on the display device. In the example illustrated in FIG. 5, a dotted line indicating the contour of the entry-prohibited area AR is displayed on the display device. Note that the entry-prohibited area AR may be displayed on the display device in a specific color. It is sufficient for the display device to display the entry-prohibited area AR in a display form that can be recognized by the driver. As a result, the driver can confirm the position of the entry-prohibited area AR.

Note that the discharging position M, the position of the unmanned vehicle 2, and the position of the manned vehicle 9 may be displayed on the display device in FIG. 5.

In addition, the notification device 50 outputs a warning when the manned vehicle 9 enters the entry-prohibited area AR. The notification device 50 may output a warning sound or light as the warning. As a result, the driver can recognize that the manned vehicle 9 enters the entry-prohibited area AR.

The notification device 50 may output the warning before the manned vehicle 9 enters the entry-prohibited area AR. The notification device 50 may output the warning when the manned vehicle 9 is approaching the entry-prohibited area AR. The notification device 50 may change an output state of the warning based on a distance between the manned vehicle 9 and the entry-prohibited area AR. For example, the notification device 50 may increase the warning sound as the manned vehicle 9 approaches the entry-prohibited area AR.

When the manned vehicle 9 has entered the entry-prohibited area AR, the notification device 50 performs a notification in a specified notification form. The specified notification form includes outputting a specified warning sound and outputting light of a specified color. The notification device 50 may continue outputting the warning after the manned vehicle 9 has entered the entry-prohibited area AR, or may stop outputting the warning after outputting the warning for a predetermined time.

<Management Method>

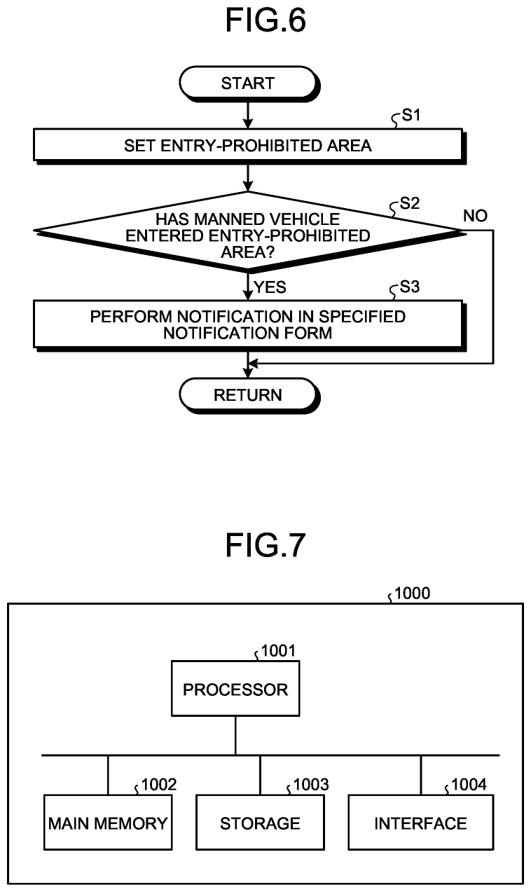

FIG. 6 is a flowchart illustrating an example of a management method according to the embodiment. The entry-prohibited area setting unit 3B sets the entry-prohibited area AR (Step S1).

The determination unit 3C determines whether the manned vehicle 9 has entered the entry-prohibited area AR based on the position of the manned vehicle 9 and the entry-prohibited area AR set by the entry-prohibited area setting unit 3B (Step S2).

The determination unit 3C can determine whether the manned vehicle 9 has entered the entry-prohibited area AR based on the detection data of the position detection device 28.

If it is determined in Step S2 that the manned vehicle 9 has entered the entry-prohibited area AR (Step S2: Yes), the notification unit 3D notifies the manned vehicle 9 that the manned vehicle 9 has entered the entry-prohibited area AR (Step S3).

The notification device 50 of the manned vehicle 9 notifies that the manned vehicle 9 has entered the entry-prohibited area AR in the prescribed notification form. The notification device 50 may continue outputting the warning after the manned vehicle 9 has entered the entry-prohibited area AR, or may stop outputting the warning after outputting the warning for a predetermined time. As a result, the driver can recognize that the manned vehicle 9 has entered the entry-prohibited area AR.

If it is determined in Step S2 that the manned vehicle 9 has not entered the entry-prohibited area AR (Step S2: No), the notification device 50 does not perform a notification.

<Effect>

As described above, the notification unit 3D that notifies the manned vehicle 9 of the entry-prohibited area AR is provided according to the present embodiment. Since the entry-prohibited area AR is displayed on the display device of the notification device 50, the driver of the manned vehicle 9 can operate the manned vehicle 9 so as not to enter the entry-prohibited area AR. When the manned vehicle 9 has entered the entry-prohibited area AR, the warning is output from the notification device 50 in the specified notification form, so that the driver can recognize that the manned vehicle 9 has entered the entry-prohibited area AR and drive the manned vehicle 9 so as to exit the entry-prohibited area AR. Since the manned vehicle 9 is suppressed from entering a work area of the unmanned vehicle 2, deterioration in the safety at the work site is suppressed.

[Computer System]

FIG. 7 is a block diagram illustrating an example of a computer system 1000. Each of the management device 3, the control device 30, and the control device 40 described above includes the computer system 1000. The computer system 1000 includes: a processor 1001 such as a central processing unit (CPU); a main memory 1002 including a nonvolatile memory such as a read only memory (ROM) and a volatile memory such as a random access memory (RAM); a storage 1003; and an interface 1004 including an input/output circuit. The respective functions of the management device 3, the control device 30, and the control device 40 described above are stored in the storage 1003 as programs. The processor 1001 reads the program from the storage 1003, expands the read program in the main memory 1002, and executes the above-described processing according to the program. Note that the program may be delivered to the computer system 1000 via a network.

The computer system 1000 can execute setting the entry-prohibited area AR to prohibit the entry of the manned vehicle 9 at the work site and notifying the notification device 50 provided in the manned vehicle 9 of the entry-prohibited area AR according to the above embodiment.

### Other Embodiments

In the above embodiment, the management device 3 may stop the traveling of the unmanned vehicle 2 existing in the entry-prohibited area AR when the manned vehicle 9 has entered the entry-prohibited area AR.

In the above embodiment, the notification device 50 may perform a notification in a notification form different from the above-described specified notification form when the manned vehicle 9 is approaching the entry-prohibited area AR. The notification form when the manned vehicle 9 is approaching the entry-prohibited area AR includes outputting a warning sound different from the specified warning sound and outputting colored light different from the light of the specified color. The notification device 50 may continue outputting the warning during a period when the manned vehicle 9 is approaching the entry-prohibited area AR.

In the above embodiment, at least some of the functions of the control device 30 and the functions of the control device 40 may be provided in the management device 3, and at least some of the functions of the management device 3 may be provided in the control device 30 and the control device 40. For example, the function of the determination unit 3C may be provided in the control device 30 of the manned vehicle 9. The entry-prohibited area AR generated by the management device 3 may be transmitted to the control device 30 of the manned vehicle 9, and the determination unit 3C of the control device 30 may determine whether the manned vehicle 9 has entered the entry-prohibited area AR. In addition, the function of the notification unit 3D may be provided in the control device 30 of the manned vehicle 9. The entry-prohibited area AR generated by the management device 3 may be transmitted to the control device 30 of the manned vehicle 9, and the notification unit 3D of the control device 30 may notify the notification device 50 of the entry-prohibited area AR or notify the notification device 50 that the manned vehicle 9 has entered the entry-prohibited area AR or that the manned vehicle 9 is approaching the entry-prohibited area AR.

Note that the travel course data is generated in the management device 3, and the unmanned vehicle 2 travels according to the travel course data transmitted from the management device 3 in the above embodiment. The control device 30 of the unmanned vehicle 2 may generate the travel course data. That is, the control device 30 may have the travel course data generation unit 3A. In addition, each of the management device 3 and the control device 30 may have the travel course data generation unit 3A.

Note that the unmanned vehicle 2 and the manned vehicle 9 are assumed as the dump truck which is a kind of transport vehicle in the above embodiment. The unmanned vehicle 2 and the manned vehicle 9 may be work machines equipped with working equipment such as an excavator and a bulldozer.

### REFERENCE SIGNS LIST

1 MANAGEMENT SYSTEM

2 UNMANNED VEHICLE

3 MANAGEMENT DEVICE

3A TRAVEL COURSE DATA GENERATION UNIT

3B ENTRY-PROHIBITED AREA SETTING UNIT

3C DETERMINATION UNIT

3D NOTIFICATION UNIT

4 COMMUNICATION SYSTEM

5 CONTROL FACILITY

6 WIRELESS COMMUNICATION DEVICE

7 LOADER

9 MANNED VEHICLE

21 TRAVELING DEVICE

22 VEHICLE MAIN BODY

23 DUMP BODY

24 DRIVE DEVICE

25 BRAKE DEVICE

26 STEERING DEVICE

27 WHEEL

27F FRONT WHEEL

27R REAR WHEEL

28 POSITION DETECTION DEVICE

29 WIRELESS COMMUNICATION DEVICE

30 CONTROL DEVICE

40 CONTROL DEVICE

50 NOTIFICATION DEVICE

1000 COMPUTER SYSTEM

1001 PROCESSOR

1002 MAIN MEMORY

1003 STORAGE

1004 INTERFACE

CP COURSE POINT

CR TRAVEL COURSE

PA WORK SITE

DPA DISCHARGING SITE

M DISCHARGING POSITION

Ma DISCHARGING POSITION

HL TRAVEL PATH

IS INTERSECTION

1. A work site management system comprising:
an entry-prohibited area setting unit that sets an entry-prohibited area to prohibit an entry of a manned transport vehicle at a discharging site in a work site; and
a notification unit that notifies the manned transport vehicle of the entry-prohibited area.

2. The work site management system according to claim 1, wherein the entry-prohibited area setting unit sets the entry-prohibited area so as to include a discharging position where discharging work of an unmanned transport vehicle is carried out.

3. The work site management system according to claim 1, wherein
the notification unit notifies that the manned transport vehicle has entered the entry-prohibited area.

4. The work site management system according to claim 1, comprising
a determination unit that determines whether the manned transport vehicle enters the entry-prohibited area based on a position of the manned transport vehicle.

5. The work site management system according to claim 1, wherein
an entry of an unmanned transport vehicle to the entry-prohibited area is permitted.

6. A work site management method comprising:
setting an entry-prohibited area to prohibit an entry of a manned transport vehicle at a discharging site in a work site; and
notifying the manned transport vehicle of the entry-prohibited area.
